(19) United States
(12) Patent Application Publication
(10) Pub. No.: US 2011/0261281 A1
(43) Pub. Date: Oct. 27, 2011

(54) LCD ASSEMBLY AND PORTABLE ELECTRONIC DEVICE UTILIZING SAME

(75) Inventors: CHUAN-I LIU, Shindian (TW); BO YANG, Shenzhen (CN); XIAO-ZHOU HU, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/868,826

(22) Filed: Aug. 26, 2010

(30) Foreign Application Priority Data
Apr. 23, 2010 (CN) 201010154333.1

(51) Int. Cl. G02F 1/1333

(52) U.S. Cl. 349/58

(57) ABSTRACT

A liquid crystal display assembly includes a printed circuit board, a liquid crystal display module, and a reinforcing plate. A frame projects from a surface at one side of the printed circuit board. The frame defines a receiving space. The liquid crystal display module is received in the receiving space and retained by the frame. The reinforcing plate is secured to a surface at an opposite side of the printed circuit board at a location corresponding to the liquid crystal display module.

### BACKGROUND

1. Technical Field

The disclosure generally relates to liquid crystal display (LCD) assemblies and, particularly, to an LCD assembly and a portable electronic device utilizing the LCD assembly.

2. Description of Related Art

LCD assemblies are widely used in portable electronic devices, such as personal digital assistants (PDAs), mobile phones, etc. Often, the LCD assembly includes an LCD module, a driving circuit for driving the LCD module, and a housing to secure the LCD module and the driving circuit. A recent trend in the design of LCD assemblies is toward thinner and lighter weight configurations, particularly when they are to be used in portable electronic devices. However, the LCD assemblies may be mechanically weak when manufactured to be very thin and lightweight.

Therefore, there is room for improvement within the art.

### BRIEF DESCRIPTION OF THE DRAWINGS

Many aspects of the exemplary LCD assembly and portable electronic device can be better understood with reference to the following drawings. The components in the drawings are not necessarily drawn to scale, the emphasis instead being placed upon clearly illustrating the principles of the LCD assembly and portable electronic device. Moreover, in the drawings, like reference numerals designate corresponding parts throughout the several views, in which:

FIG. 1 is an assembled, isometric view of a first embodiment of an LCD assembly for a portable electronic device;

FIG. 2 is an exploded view of the LCD assembly of FIG. 1;

FIG. 3 is enlarged view of a circled portion III of FIG. 1;

FIG. 4 is an exploded, isometric view of a second embodiment of an LCD assembly for a portable electronic device; and

FIG. 5 is an exploded, isometric view of a third embodiment of an LCD assembly for a portable electronic device.

### DETAILED DESCRIPTION

The disclosure is illustrated by way of example and not by way of limitation in the accompanying drawings. It should be noted that references to “an” or “one” embodiment in this disclosure are not necessarily to the same embodiment, and such references can include the meaning of “at least one” embodiment where the context permits.

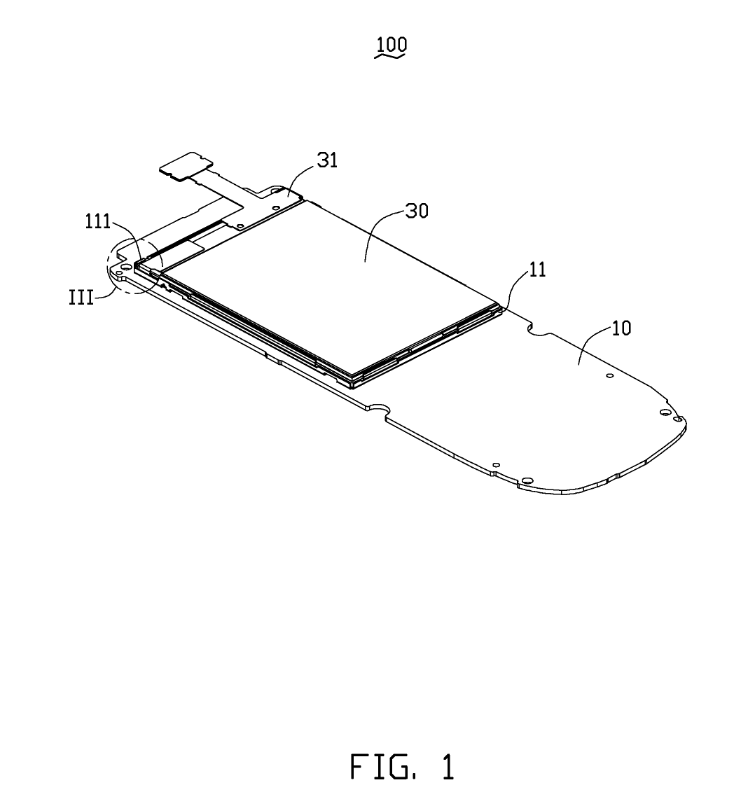

FIG. 1 shows a first embodiment of an LCD assembly 100 for a portable electronic device, such as a cellular phone or other electronic device where an LCD assembly is employed. The LCD assembly 100 includes a printed circuit board (PCB) 10, a reinforcing plate 20, and an LCD module 30. The reinforcing plate 20 and the LCD module 30 are secured on opposite sides of the PCB 10 at corresponding locations, so that the reinforcing plate 20 can improve the strength (or rigidity) of the PCB 10 to help protect the LCD assembly 100 from damage due to impact.

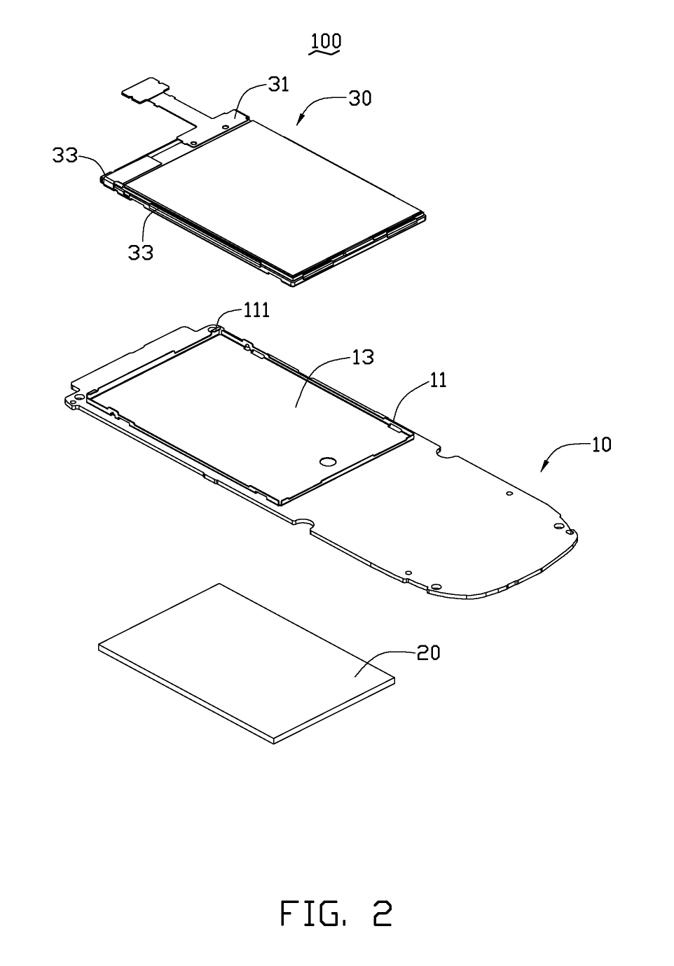

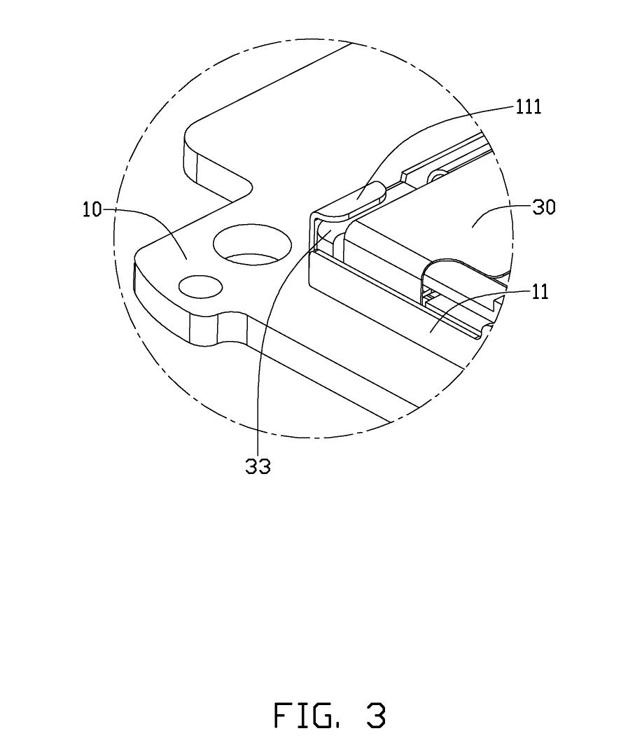

Referring also to FIGS. 2 and 3, a frame 11 perpendicularly projects from a top surface of the PCB 10, and a receiving space 13 is defined by the frame 11 to receive the LCD module 30. A plurality of catches 111 extend from corners of the frame 11. In assembly of the LCD assembly 100, a free end of each catch 111 is bent at an angle with respect to the frame 11 by an operator. Thereby, the LCD module 30 is secured in the receiving space 13.

The reinforcing plate 20 is a rectangular sheet, and is generally formed of metal such as stainless steel in the first exemplary embodiment. The reinforcing plate 20 is configured to cover substantially the same area of the PCB 10 as is occupied by the receiving space 13. The reinforcing plate 20 is fixed to a bottom surface of the PCB 10 by laser welding or fusion, for example.

The LCD module 30 is for displaying information for the portable electronic device. The LCD module 30 includes a driving circuit 31 either directly electronically connected to the PCB 10 or electronically connected to the PCB 10 via a flexible printed circuit (FPC). In the illustrated embodiment, the driving circuit 31 is electronically connected to the PCB 10 via an FPC (not labeled). A plurality of ribs 33 project from sidewalls of the LCD module 30 to abut the inner surface of the frame 11.

During assembly, the LCD module 30 is received in the receiving space 13 and abuts the top surface of the PCB 10, and the ribs 33 abut the inner surface of the frame 11. The free end of each catch 111 is bent down toward the receiving space 13 and abuts or resists a corresponding rib 33 of the LCD module 30. The reinforcing plate 20 is fixed to the bottom surface of the PCB 10 by laser welding or fusion, for example. Thus, the LCD assembly 100 is assembled as shown in FIG. 1.

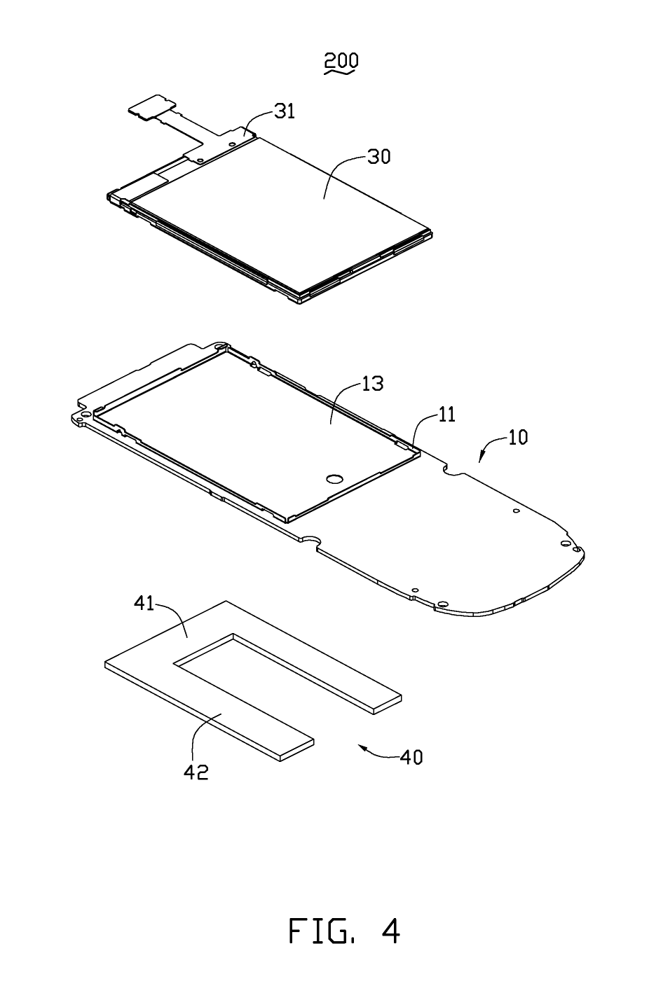

Referring to FIG. 4, in a second embodiment, an LCD assembly 200 includes a PCB 10, an LCD module 30, and a U-shaped reinforcing plate 40 made of metal. The reinforcing plate 40 includes a base portion 41 and two arms 42. The arms 42 extend from opposite ends of the base portion 41, and are parallel to each other. After the reinforcing plate 40 and the LCD module 30 are attached to opposite surfaces of the PCB 10, the base portion 41 and the arms 42 support and reinforce the PCB 10.

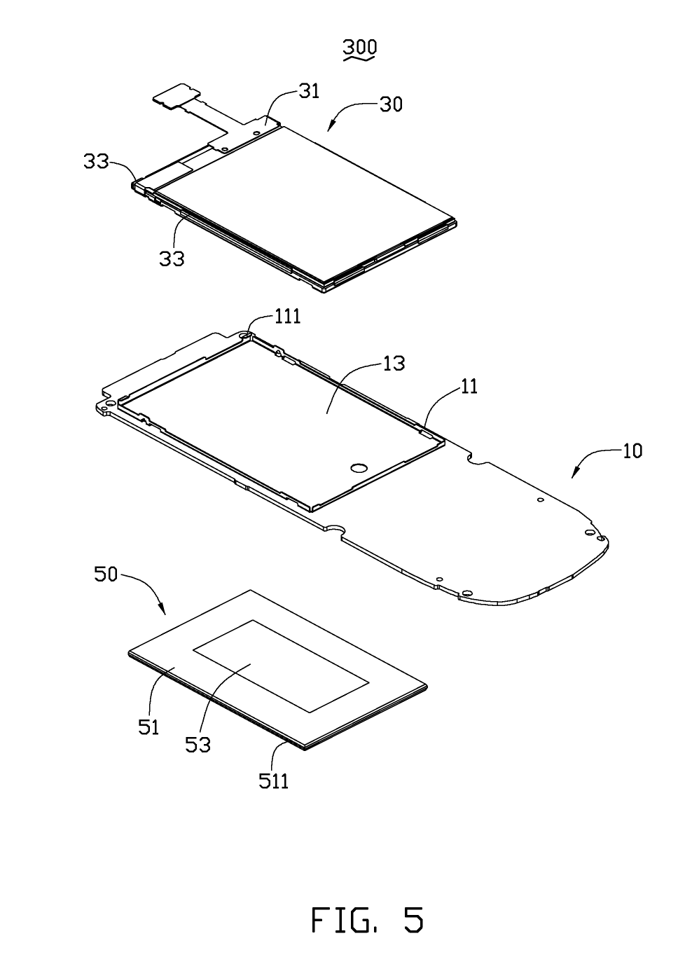

Referring to FIG. 5, in a third embodiment, an LCD assembly 300 includes a PCB 10, an LCD module 30, and a reinforcing plate 50. The reinforcing plate 50 includes a frame-shaped peripheral portion 51 and a central cushion 53. The peripheral portion 51 is made of metal and the cushion 53 is made of rubber, and they are integrally formed by insert molding. That is, the reinforcing plate 50 is a one-piece insert-molded body, which includes the cushion 53 and the peripheral portion 51. A plurality of beads 511 project from sidewalls of the peripheral portion 51, to fix the reinforcing plate 50 to a housing (not shown) of the portable electronic device. The reinforcing plate 50 and the LCD module 30 are attached to opposite surfaces of the PCB 10. The peripheral portion 51 reinforces the PCB 10 while the cushion 53 absorbs the force of impacts. The housing (not shown) of the portable electronic device accommodates the PCB 10, the LCD module 30, and the reinforcing plate 50.

The above-described exemplary embodiments of the LCD assembly include a reinforcing plate. Thus the PCB is reinforced, and the LCD assembly and portable electronic device can remain intact and operate reliably for a long period.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A liquid crystal display assembly comprising:
a printed circuit board, a frame projecting from a surface at one side of the printed circuit board, the frame defining a receiving space;
a liquid crystal display module received in the receiving space and retained by the frame; and
a reinforcing plate secured to a surface at an opposite side of the printed circuit board at a location corresponding to the liquid crystal display module.

2. The liquid crystal display assembly of claim 1, wherein a plurality of catches extend from the frame, and a free end of each catch is bent and abuts or resists the liquid crystal display module.

3. The liquid crystal display assembly of claim 2, wherein a plurality of ribs project from sidewalls of the liquid crystal display module, and the ribs abut the inner surface of the frame.

4. The liquid crystal display assembly of claim 3, wherein the liquid crystal display module includes a driving circuit electrically connected to the printed circuit board.

5. The liquid crystal display assembly of claim 1, wherein the reinforcing plate is a rectangular sheet of metal.

6. The liquid crystal display assembly of claim 1, wherein the reinforcing plate includes a base portion and two parallel arms extending from opposite ends of the base portion, and the base portion and the two arms support the printed circuit board.

7. The liquid crystal display assembly of claim 1, wherein the reinforcing plate is a one-piece insert-molded body, which includes a cushion and a peripheral portion surrounding the cushion, and the peripheral portion is made of metal.

8. The liquid crystal display assembly of claim 1, wherein an area of the reinforcing plate is substantially the same as a corresponding area of the receiving space.

9. A portable electronic device comprising:
a printed circuit board, a frame projecting from a major surface of one side of the printed circuit board and defining a receiving space;
a liquid crystal display module received in the receiving space and retained by the frame;
a reinforcing plate secured to a major surface of an opposite side of the printed circuit board at a location corresponding to the liquid crystal display module; and
a housing accommodating the printed circuit board, the liquid crystal display module, and the reinforcing plate.

10. The portable electronic device of claim 9, wherein a plurality of catches extend from the frame, and a free end of each catch is bent and abuts or resists the liquid crystal display module.

11. The portable electronic device of claim 10, wherein a plurality of ribs project from sidewalls of the liquid crystal display module, and the ribs abut the inner surface of the frame.

12. The portable electronic device of claim 11, wherein the liquid crystal display module includes a driving circuit electrically connected to the printed circuit board.

13. The portable electronic device of claim 9, wherein the reinforcing plate is a rectangular sheet of metal.

14. The portable electronic device of claim 9, wherein the reinforcing plate includes a base portion and two parallel arms extending from opposite ends of the base portion, and the base portion and the two arms support the printed circuit board.

15. The portable electronic device of claim 9, wherein the reinforcing plate is a one-piece insert-molded body, which includes a cushion and a peripheral portion surrounding the cushion, and the peripheral portion is made of metal.
